(19) United States
(12) Patent Application Publication
(10) Pub. No.: US 2023/0307851 A1
(43) Pub. Date: Sep. 28, 2023

(54) TERMINAL CONNECTION STRUCTURE OF ENAMELED WIRE OF COMPRESSOR MOTOR

(71) Applicant: RECHI PRECISION CO., LTD., Taoyuan City (TW)

(72) Inventors: CHEN-NAN CHU, Taoyuan City (TW); TING-YANG CHENG, Taoyuan City (TW); LUNG-HSUAN TSENG, Taoyuan City (TW)

(21) Appl. No.: 18/071,480

(22) Filed: Nov. 29, 2022

(30) Foreign Application Priority Data
Mar. 24, 2022 (CN) 2022206514193

(51) Int. Cl. H01R 4/18

(52) U.S. Cl. CPC H01R 4/184

(57) ABSTRACT

A terminal connection structure includes a terminal and an enameled wire. The terminal includes a socket and a conductor crimping portion. The conductor crimping portion includes a first crimping area and a second crimping area, and the first crimping area and the second crimping area are both U-shaped before crimped. The enameled wire is located in the first crimping area and the second crimping area, wherein the enameled wire includes three conducting wires and an enameled film covering the conducting wires. The first crimping area and the second crimping area are crimped to be in a shape of a semi-circular thereby crimping the three conducting wires tightly. Wherein an outer width of the second crimping area after crimped is W2, an outer diameter of the enameled wire is D, a thickness of the second crimping area is t, and the following condition is satisfied: W2≥D×0.8+2t.

### RELATED APPLICATIONS

This application claims priority to China Application Serial Number 202220651419.3, filed Mar. 24, 2022, which is herein incorporated by reference.

### BACKGROUND

### Technical Field

The present disclosure relates to a compressor, especially relates to a terminal connection structure of an enameled wire of a compressor motor.

### Description of Related Art

A compressor is an important component of household appliances (e.g., air conditioner, refrigerator, etc.) that utilizes a refrigeration cycle system to work. The compressor mainly includes components such as exhaust pipe, case, motor (stator, rotor), driving shaft, upper bearing, muffler cover, compression unit (cylinder, piston), lower bearing, bottom cover, outlet pipe, reservoir and inlet pipe, etc. The compression unit (cylinder, piston) of the compressor converts mechanical energy into compression energy through the driving shaft driven by the motor, and to produce a compression pressure of the refrigerant in the cylinder of the compression unit. The motor converts electrical energy into rotational and mechanical energy through the rotation of the corresponding components when a current magnetic field is applied, thereby providing power to operate the compressor. Therefore, the motor is an important component of the compressor, and the performance of the motor directly affects the functionality of the compressor.

The motor commonly includes a stator and a rotor. The stator and the rotor are made of iron cores respectively, and the iron cores are made of stacked silicon steel sheets. A single iron chip of the stator is in a shape of a circular ring, and the iron core of the stator formed from stacking the iron chips is in a shape of a barrel. The rotor is in a shape of a cylinder. The rotor is for assembling a driving shaft and is inserted into a barrel cavity of the iron core of the stator. An air gap is formed between the rotor and the stator. A winding twined by enameled wires is disposed on the stator. The winding of the stator generates a magnetic field when a current of an external power is supplied. The rotor interacts with the magnetic field of the stator to generate an electromagnetic torque and rotates inside the stator when the current is flowed therethrough.

In the existing technology, a copper enameled wire is mainly used for refrigeration compressors. However, the cost of the material of the copper enameled wire is high. For reducing the cost, many enterprises use aluminum enameled wire as the winding of the motor. In general, in order to make a connection between the aluminum enameled wire and a lead wire (braided wire), an enameled film is manually removed from the aluminum enameled wire, and then a terminal is used to crimp the aluminum enameled wire and the lead wire (braided wire), and then the connector is insulated with polyester sleeves. Therefore, the production efficiency of this method is low, and the aluminum enameled wire is easily oxidized, thus a dummy soldering phenomenon is occurred frequently after a certain period of time.

Some related industries have done researches to eliminate the disadvantages mentioned above. For example, China Patent Grant Serial Number CN202134663U discloses a connection terminal of aluminum enameled wire of refrigeration compressor motor. The connection terminal includes an aluminum enameled wires and a lead wire (braided wire). The aluminum enameled wire and the lead wire (braided wire) are overlapped up and down and are covered and crimped by a metal sheet. The inner surface of the metal sheet has stabbing sheets which can stab the enameled film of the aluminum enameled wire. Owing to the metal sheet of the terminal has stabbing sheets in its inner surface, the enameled film of the enameled wire can be stabbed by the stabbing sheets and being conductive during the crimping process, thus there is no need to remove the enameled film preliminary, therefore the disadvantages such as low productivity, oxidation of the aluminum wire and false soldering in the existing technology can be eliminated.

However, the lead wire of the above-mentioned refrigeration compressor motor is mostly made of a braided wire and is formed through the assembly of the connection terminal and the winding of the motor. Owing to the limitation of the shape of the terminal, only two conducting wires (aluminum wires) can be disposed in the enameled wire, thus the functionalities of the motor and the design capability of the parameters of the winding will be affected.

### SUMMARY

According to one aspect of the present disclosure, a terminal connection structure of an enameled wire of a compressor motor is provided. The terminal connection structure includes a terminal and an enameled wire. The terminal includes a socket and a conductor crimping portion. The socket is formed in one end of the terminal, wherein the socket includes a preformed shape. The conductor crimping portion is formed in the other end of the terminal, wherein the conductor crimping portion includes a first crimping area and a second crimping area, and the first crimping area and the second crimping area are both U-shaped before crimped. The enameled wire is located in the first crimping area and the second crimping area, wherein the enameled wire includes three conducting wires and an enameled film covering the conducting wires. The first crimping area and the second crimping area are crimped to be in a shape of a semi-circular thereby crimping the conducting wires tightly. Wherein an outer width of the second crimping area after crimped is W2, an outer diameter of the enameled wire is D, a thickness of the second crimping area is t, and the following condition is satisfied: W2≤D×0.8+2t.

### BRIEF DESCRIPTION OF THE DRAWINGS

The present disclosure can be more fully understood by reading the following detailed description of the embodiment, with reference made to the accompanying drawings as follows:

FIG. 1 is a schematic view showing a terminal of a terminal connection structure of an enameled wire of a compressor motor before crimped according to one embodiment of the present disclosure;

FIG. 2 is a schematic view showing a terminal and an enameled wire of a terminal connection structure of an enameled wire of a compressor motor before crimped according to one embodiment of the present disclosure;

FIG. 3 is a cross-sectional view of the second crimping area of the terminal and the enameled wire of FIG. 2 before crimped;

FIG. 4 is a schematic view showing a terminal and an enameled wire of a terminal connection structure of an enameled wire of a compressor motor after crimped according to one embodiment of the present disclosure;

FIG. 5 is a cross-sectional view of the second crimping area of the terminal and the enameled wire of FIG. 4 after crimped;

FIG. 6 is a schematic view showing a terminal connection structure of an enameled wire of a compressor motor according to another embodiment of the present disclosure; and

FIG. 7 is a partially enlarged view of FIG. 6.

### DETAILED DESCRIPTION

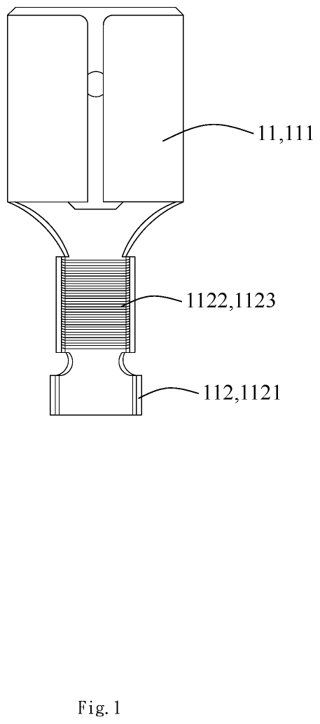

FIGS. 1, 2, 3, 4, 5 show the structure of a terminal connection structure 1 of an enameled wire of a compressor motor. The terminal connection structure 1 includes a terminal 11 and an enameled wire 12.

The terminal 11 is made of a metallic conductor material. A socket 111 is formed in one end of the terminal 11. The socket 111 has a preformed shape. Here the “preformed shape” indicates that the shape of the socket 111 can be changed, any structural geometry of this kind of socket in the current market can possibly be applied. A conductor crimping portion 112 is formed in the other end of the terminal 11. The conductor crimping portion 112 includes a first crimping area 1121 and a second crimping area 1122. The first crimping area 1121 and the second crimping area 1122 are both U-shaped before crimped. The terminal 11 further includes a puncture structure 1123. The puncture structure 1123 is located in the second crimping area 1122. In more detail, the puncture structure 1123 is located on an inner surface of the second crimping area 1122 and is adjacent to a surface of the conductor crimping portion 112 of the second crimping area 1122. However, the location of the puncture structure 1123 can be changed. The puncture structure 1123 can also be located on the inner surface of the second crimping area 1122 only. The puncture structure 1123 can be horizontally or vertically arranged. The puncture structure 1123 can also be a dentate protrusion or a reticular protrusion. In one embodiment of the present disclosure, the puncture structure 1123 is a dentate protrusion and is horizontally arranged on the inner surface of the second crimping area 1122 and is adjacent to the surface of the conductor crimping portion 112 of the second crimping area 1122. In one embodiment, the puncture structure 1123 and the second crimping area 1122 are integrally formed, and the socket 111 and the conductor crimping portion 112 are also integrally formed (as shown in FIG. 1).

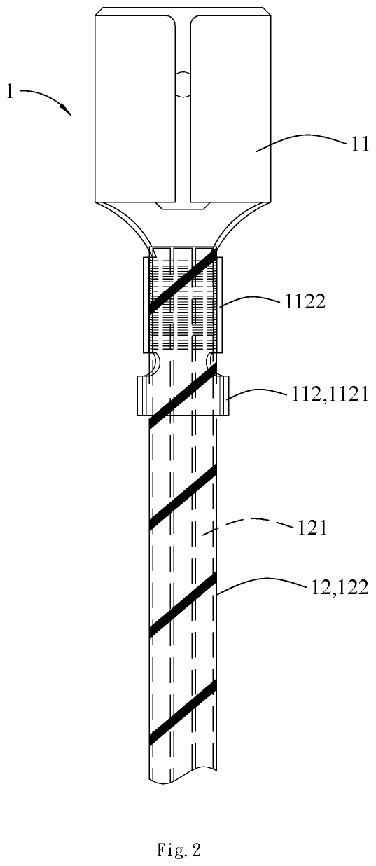

The enameled wire 12 is located in the first crimping area 1121 and the second crimping area 1122 of the conductor crimping portion 112. In the embodiment, the terminal 11 and the enameled wire 12 are not crimped. The enameled wire 12 includes three conducting wires 121 and an enameled film 122. The enameled film 122 is used to cover the conducting wires 121 therein, and then the enameled wire 12 is located in the first crimping area 1121 and the second crimping area 1122 (as shown in FIG. 2).

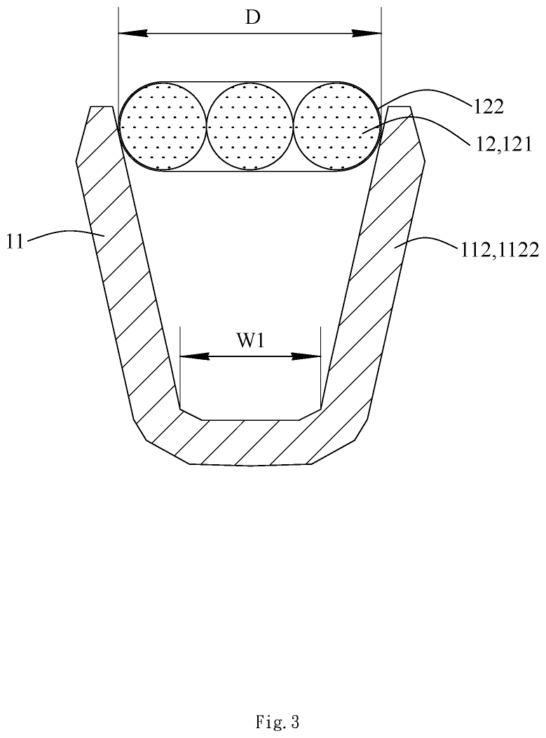

Before crimped, the second crimping area 1122 is U-shaped, where a bottom width of the second crimping area 1122 is W1, an outer diameter of the enameled wire 12 is D, and the following condition is satisfied: W1/D≤0.5. In detail, the outer diameter D of the enameled wire 12 is a sum of the outer diameter of the three conducting wires 121 and the enameled film 122. Before crimped, owing to the U-shaped second crimping area 1122, the bottom width W1 thereof must be greater than 50% of sum of the outer diameter of the three conducting wires 121 and the enameled film 122 (as shown in FIG. 3).

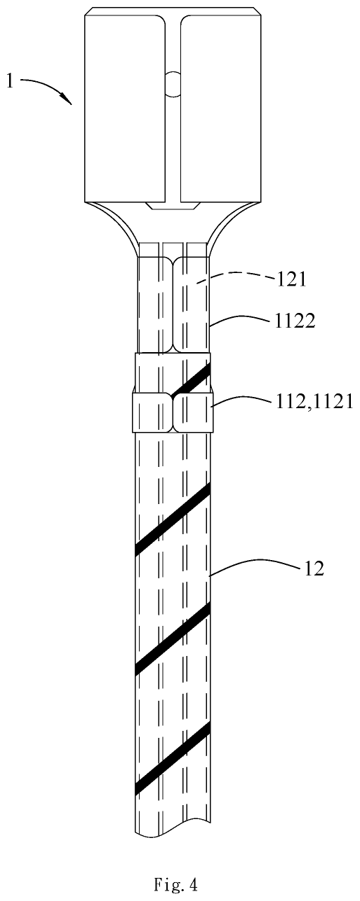

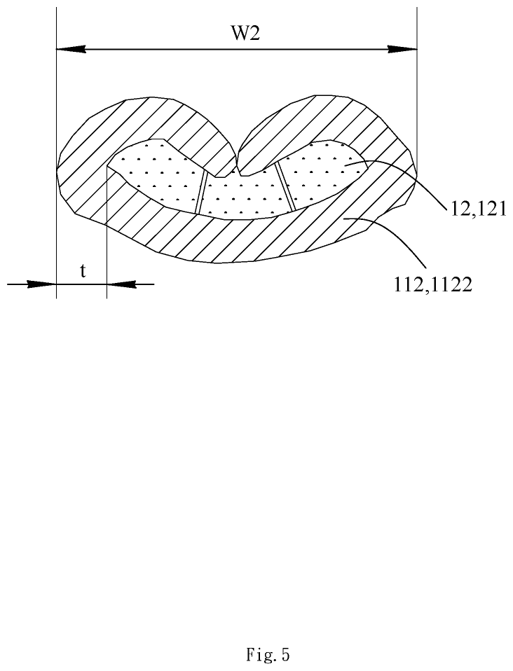

In the embodiment mentioned above, after being crimped, the first crimping area 1121 and the second crimping area 1122 are crimped to be in a shape of a semi-circular thereby crimping the three conducting wires 121 tightly, and then the terminal connection structure 1 of the present disclosure is formed. Where an outer width of the second crimping area 1122 after crimped is W2, the outer diameter of the enameled wire 12 is D, a thickness of the second crimping area 1122 is t, and the following condition is satisfied: W2≥D×0.8+2t (as shown in FIG. 4 and FIG. 5).

In the embodiment mentioned above, the enameled wire 12 is crimped by the first crimping area 1121 and the second crimping area 1122. When the second crimping area 1122 is crimped, the puncture structure 1123 in the second crimping area 1122 punctures the enameled film 122 of the enameled wire 12 to make the terminal 11 and the three conducting wires 121 of the enameled wire 12 be on a conducting state. Therefore, in the connection portion of the three conducting wires 121 and the conductor crimping portion 112, there is no need to completely remove the enameled film 122, the electric connection can be made by contacting an exposed part of a partially removed enameled film 12 with the conductor crimping portion 112.

In the embodiment mentioned above, the three conducting wires 121 of the enameled wire 12 can all be aluminum wires or can be a combination of aluminum wires and copper wires. For example, the three conducting wires 121 can be a combination of one copper wire and two aluminum wires or a combination of one aluminum wire and two copper wires. A wire diameter of each of the three conducting wires 121 is ranged between 0.35 mm and 1.2 mm.

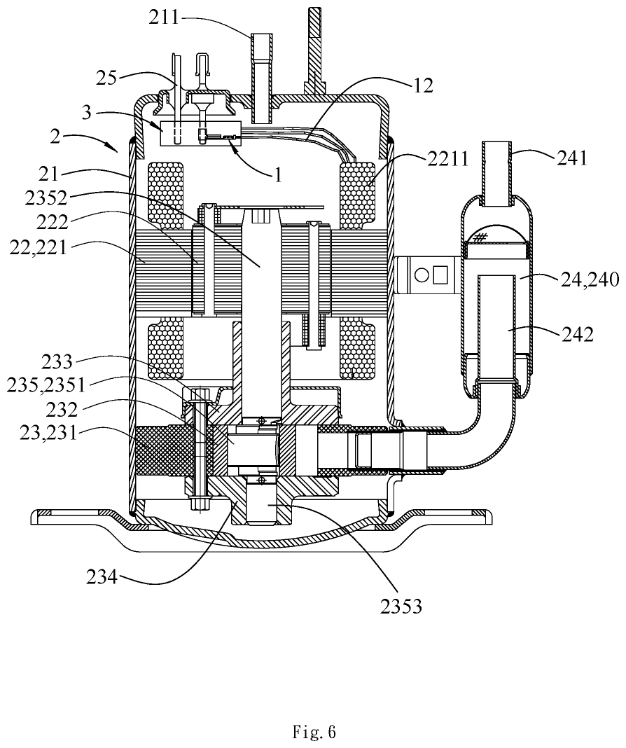

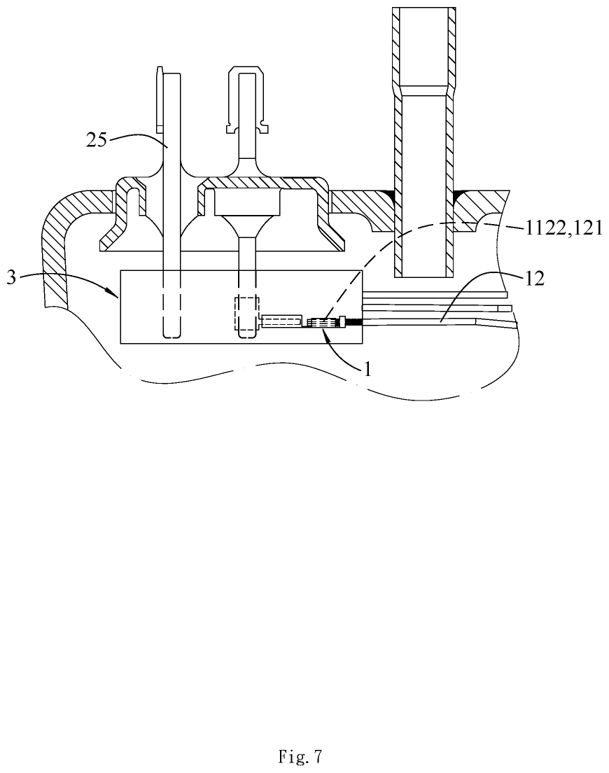

FIG. 6 and FIG. 7 show a terminal connection structure of an enameled wire of a compressor motor according to another embodiment of the present disclosure. FIGS. 1 to 5 are also referred herein. The terminal connection structure 1 in FIG. 6 and FIG. 7 includes a terminal 11 and an enameled wire 12. The detail descriptions of the structure of the terminal 11 and the enameled wire 12 were described in the aforementioned embodiments and are not repeated herein.

The terminal connection structure 1 of the present disclosure is utilized in a compressor 2. The basic structure of the compressor 2 includes a shell 21, a motor 22, a compression pump 23, a filtering bottle 24 and an electrical connector assembly 25. The compressor 2 can be a vertical compressor or a horizontal compressor. In the present disclosure, the compressor 2 is a vertical compressor.

The shell 21 has a hollow body for accommodating the components such as the motor 22 and the compression pump 23, etc. The shell 21 includes an outlet pipe 211. The outlet pipe 211 is disposed on the top or side of the shell 21. In the present disclosure, the outlet pipe 211 is disposed on the top of the shell 21. The bottom of the shell 21 can be used to store refrigerant oil. The structural geometry of the shell 21 is not limited, any kind of shell 21 being reachable in the market can be utilized.

The motor 22 is disposed in the shell 21. The motor 22 includes a stator 221 and a rotor 222. The stator 221 is fixed on an inner wall of the shell 21. The rotor 22 is rotatably disposed on an inner side of the stator 221. The structural geometry of the motor 22 is not limited, any kind of motor 22 being reachable in the market can be utilized.

The compression pump 23 is disposed in the shell 21 and is located under the motor 22. The compression pump 23 includes at least one cylinder 231, at least one ring 232, an upper support 233, a lower support 234 and a crankshaft 235. The cylinder 231 is disposed in the shell 21 and is located under the motor 22. The ring 232 is rotatably disposed in the cylinder 231. The upper support 233 is disposed in the shell 21 and is located above the cylinder 231. The lower support 234 is disposed in the shell 21 and is located under the cylinder 231. The crankshaft 235 is disposed in the shell 21 and is longitudinally extended with a proper length. The crankshaft 235 includes at least one eccentric portion 2351. The eccentric portion 2351 is located in a lower end of the crankshaft 235 with a distance. The crankshaft 235 has an upper shaft part 2352 and a lower shaft part 2353. The upper shaft part 2352 is for assembling the upper support 233 and the rotor 222 of the motor 22. The lower shaft part 2353 is for assembling the lower support 235. The eccentric portion 2351 is for assembling the ring 232 of the cylinder 231. The structural geometry of the compression pump 23 is not limited, any kind of compression pump 23 being reachable in the market can be utilized.

The quantity of the cylinder 231 and the ring 232 is not limited. The compression pump 23 can be a single cylinder type or a double cylinder type, thus the quantity of the cylinder 231 and the sing 232 can be one or two, and the ring 232 is rotatably disposed in the cylinder 231. In the present disclosure, the compression pump 23 is a single cylinder type.

The filtering bottle 24 is made of metallic material. The filtering bottle 24 is longitudinally extended with a proper length. An accommodating space 240 is formed in the filtering bottle 24. An inlet pipe 241 is disposed on the top of the filtering bottle 24. At least one inner pipe 242 is disposed in the filtering bottle 24. The inner pipe 242 is extended outward of the filtering bottle 24 and is connected with the compression pump 23. The filtering bottle 24 is located on one side of the shell 21, and a fluid (refrigerant) can be supplied through the filtering bottle 24 and into the compressor 2. In detail, the inner pipe 242 of the filtering bottle 24 is connected with the cylinder 231 of the compression pump 23, and a refrigeration cycle system is connected between the inlet pipe 241 of the filtering bottle 24 and the outlet pipe 211 of the shell 21 of the compressor 2. The quantity of the inner pipe 242 of the filtering bottle 24 is selectable in accordance with the type (single cylinder type or double cylinder type) of the compression pump 23. The structural geometry of the filtering bottle 24 is not limited, any kind of the filtering bottle 24 being reachable in the market can be utilized.

The electrical connector assembly 25 can be disposed on the top or side of the shell 21. In the present disclosure, the electrical connector assembly 25 is disposed on the top of the shell 21 and is electrically connected with the motor 22. The structural geometry of the electrical connector assembly 25 is not limited, any kind of the electrical connector assembly 25 being reachable in the market can be utilized.

The stator 221 of the motor 22 includes a winding 2211. In the present disclosure, the winding 2211 includes a plurality of conducting wires 121 (aluminum wires or a combination of aluminum wires and copper wires). The conducting wires 121 are twined in a groove (now shown in the figures) of the stator 221. Three of the conducting wires 121 are pulled out, and then the three conducting wires 121 are covered with the enameled film 122. The enameled wire 12 of the present disclosure is functioned as a lead wire. After being crimped by a crimping tool, the puncture structure 1123 punctures partial portion of the enameled film 122 of the enameled wire 12, and an electrical connection can be made by contacting an exposed part of the partially removed enameled film 12 with the conductor crimping portion 112. Therefore, the terminal 11 can be directly plugged into a protector 3, and is connected to the electrical connector assembly 25 through the protector 3. In another embodiment, the socket 111 of the terminal 11 can be connected with a conducting pillar of the electrical connector assembly 25. In the present disclosure, the terminal 11 is directly plugged into the protector 3, and is connected with the electrical connector assembly 25 through the protector 3. An outer electric power can be supplied to the stator 221 of the motor 22 by using the electrical connector assembly 25, and then the stator 221 drives the rotor 222 to rotate thereby driving the crankshaft 235 to rotate eccentrically. Thus, the eccentric portion 2351 can drive the ring 232 to rotate in the cylinder 231. The upper shaft part 2352 and the lower shaft part 2353 of the crankshaft 235 can be supported by the upper support 233 and the lower support 234 and can be rotated at high speed, and then the compression pump 23 is operated. The ring 232 is rotated eccentrically, and the refrigerant (low pressure refrigerant) which flows through the inlet pipe 241 of the filtering bottle 24 and into the accommodating space 240 is filtered, and then the refrigerant flows through the inner pipe 242 of the filtering bottle 24 then into a compression space of the cylinder 231 of the compression pump 23. In the compression space, the pressure therein is compressed to a predetermined value, thus the original refrigerant (low pressure refrigerant) is transformed to another type (high pressure refrigerant). And then the refrigerant (high pressure refrigerant) in the compression space flows into the shell 21. The rejected refrigerant (high pressure refrigerant) can flow upwardly through a gap between the shell 21 and the stator 221 or a gap between the stator 221 and the rotor 222, and then is drawn out the refrigeration cycle system through the outlet pipe 211 of the shell 21. The refrigerant can flow into the inlet pipe 241 of the filtering bottle 24 again through the refrigeration cycle system, and a cycle operation is performed.

In the present disclosure, the first crimping area 1121 and the second crimping area 1122 of the conductor crimping portion 112 of the terminal 11 are both U-shaped before crimped for locating the enameled wire 12 therein, where the bottom width of the second crimping area 1122 is W1, the outer diameter of the enameled wire 12 is D, and the following condition is satisfied: W1/D≤0.5. After being crimped, the first crimping area 1121 and the second crimping area 1122 are crimped to be in a shape of a semi-circular thereby crimping the enameled wire 12 tightly, where the outer width of the second crimping area 1122 after crimped is W2, the outer diameter of the enameled wire 12 is D, the thickness of the second crimping area 1122 is t, and the following condition is satisfied: W2≤D×0.8+2t. Under the conditions, the puncture structure 1123 in the second crimping area 1122 can be utilized to puncture the enameled film 122 of the enameled wire 12, thereby making the terminal 11 and the three conducting wires 121 of the enameled wire 12 be on a conducting state. By introducing the puncture structure 1123, no matter the three conducting wires 121 of the enameled wire 12 are three aluminum wires, three copper wires or a combination of aluminum wires and copper wires, there is no need to pre-striping the enameled wire 12, and an external lead wire (braided wire) is also not required. In the conventional refrigerant compressor, owing to the limitations on the process of crimping the terminal, the lead wires of the compressor motor are commonly formed by combining the braided wires and the winding of the motor through the connection terminal. Under the circumstances, the quantity of the wire of conventional winding can not be greater than 2, thus the functionalities of the motor are limited. In the terminal connection structure 1 of the compressor motor of the present disclosure, the winding of the motor 22 can utilize three conducting wires 121 (aluminum wires, copper wires or a combination thereof), and the striping process of the enameled film 122 of the enameled wire 12 can be simplified. Furthermore, there is no need to utilize external lead wire (braided wire), thereby increasing the design flexibility of the winding of the motor 22 as well as enhancing the functionalities of the motor 22.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A terminal connection structure of an enameled wire of a compressor motor, the terminal connection structure comprising:
a terminal comprising:
a socket formed in one end of the terminal, wherein the socket comprises a preformed shape; and
a conductor crimping portion formed in the other end of the terminal, wherein the conductor crimping portion comprises a first crimping area and a second crimping area, and the first crimping area and the second crimping area are both U-shaped before crimped; and
an enameled wire located in the first crimping area and the second crimping area, wherein the enameled wire comprises three conducting wires and an enameled film covering the conducting wires, the first crimping area and the second crimping area are crimped to be in a shape of a semi-circular thereby crimping the three conducting wires tightly;
wherein an outer width of the second crimping area after crimped is W2, an outer diameter of the enameled wire is D, a thickness of the second crimping area is t, and the following condition is satisfied:
W2≤D×0.8+2t.

2. The terminal connection structure of claim 1, wherein when the second crimping area being U-shaped before crimped, a bottom width of the second crimping area is W1, the outer diameter of the enameled wire is D, and the following condition is satisfied:
W1/D≤0.5.

3. The terminal connection structure of claim 1, further comprising:
a puncture structure located in the second crimping area;
wherein when the second crimping area is crimped, the puncture structure punctures the enameled film to make the terminal and the three conducting wires of the enameled wire be on a conducting state.

4. The terminal connection structure of claim 3, wherein the puncture structure and the second crimping area are integrally formed.

5. The terminal connection structure of claim 1, wherein the three conducting wires are aluminum wires.

6. The terminal connection structure of claim 1, wherein the three conducting wires are a combination of aluminum wires and copper wires.

7. The terminal connection structure of claim 1, wherein a wire diameter of each of the three conducting wires is ranged between 0.35 mm and 1.2 mm.

8. The terminal connection structure of claim 1, wherein the terminal is made of a metallic conductor material.
